(19) United States
(12) Patent Application Publication
(10) Pub. No.: US 2011/0106293 A1
(43) Pub. Date: May 5, 2011

(54) BOOK PROCESSING LINE INVERSION SYSTEMS AND METHODS

(76) Inventor: Steven Joseph Croghan, Lake City, IA (US)

(21) Appl. No.: 12/608,188

(22) Filed: Oct. 29, 2009

(51) Int. Cl. B65G 47/248; G06F 7/00

(52) U.S. Cl. 700/213; 414/816; 414/758; 414/771

(57) ABSTRACT

Book-turning equipment is detailed. The equipment acts on horizontally-oriented books and rotates them vertically through approximately one hundred eighty degrees without reorienting their backbones (spines). Mechanical assistance is provided only for the first approximately ninety degrees of the book rotation, however, with gravity and centrifugal forces causing the remaining rotation.

### FIELD OF THE INVENTION

This invention relates to automated processes and equipment for creating printed or other materials and more particularly, although not necessarily exclusively, to systems and methods for inverting materials such as books, magazines, etc. (or portions thereof), for purposes including, but not limited to, printing mailing addresses on rear covers.

### BACKGROUND OF THE INVENTION

U.S. Pat. No. 6,032,784 to Bellanca, et al., discloses a continuous-feed apparatus for turning books approximately ninety degrees. The apparatus receives book blocks “in upright orientation” and rotates them so that their binding edges face downward. Rotation is achieved via conveyance on an arcuate “false bottom ramp,” with the rotated blocks then conveyed on an inclined ramp to an existing ramp and thence to a clamping mechanism. No rotation of horizontally-oriented materials is suggested in the Bellanca patent, nor is any rotation through approximately one hundred eighty degrees disclosed. Similarly, no rotation for purposes of printing mailing addresses on covers is detailed.

U.S. Pat. No. 4,483,526 to Bulka, et al., mentions then-existing techniques for stacking saddle-bound books. These techniques included receiving a certain number of books in a bin or tray and then rotat[ing] the entire bin 180° before the next book is placed on top of the stack. Then a similar number of books are placed on the stack and it is rotated again.

See Bulka, col. 1,11. 49-52. According to the Bulka patent, the techniques tended to damage books and were incompatible with high-speed production equipment. The Bulka patent, therefore, proposes a different system for “slowly” rotating books through one hundred eighty degrees in a horizontal plane so as periodically to reorient their backbones. No vertical rotation occurs, however, nor is any rotation employed to facilitate printing of mailing addresses.

### SUMMARY OF THE INVENTION

The present invention provides alternate book-turning equipment for purposes other than those identified in the Bellanca and Bulka patents. The equipment acts on horizontally-oriented books and rotates them vertically through approximately one hundred eighty degrees without reorienting their backbones (spines). As a consequence, backbones of the books may continue to travel in the same orientation, while previously upwardly-facing, typically front, covers may become downwardly-facing covers for purposes of printing mailing addresses or other information on the rear covers.

Book-turning equipment of the present invention may be employed continuously. This system thus allows for rapid production, as the conveying of books need not be stopped to reorient any manually. Although not presently preferred, embodiments of the invention conceivably could be modified so as to turn books only upon command, which would allow books needing turning to be processed together with those not requiring turning.

Equipment and techniques of the invention further are configured to cause rotation through one hundred eighty degrees with mechanical assistance only through ninety degrees. Stated differently, the present invention affirmatively rotates books only through approximately ninety degrees, allowing natural forces such as gravity and centrifugal forces to rotate the books through an additional ninety degrees. This approach simplifies aspects of the equipment, as mechanical assistance is not required through full inversion of the books.

Indeed, systems of the present invention may be incorporated into existing binding (or others) lines and require only a single axis of rotation. Accordingly, only one rotating shaft is necessary. Sensors associated with the equipment may recognize when a book (or set of books) needing turning is approaching the equipment, thus causing a ninety-degree rotation of the shaft (and thereby effecting a one hundred eighty degree rotation of the book or books).

It thus is an optional, non-exclusive object of the present invention to provide equipment, systems, and techniques for turning materials.

It is another optional, non-exclusive object of the present invention to provide equipment, systems, and techniques for reorienting covers of printed materials without reorienting their backbones.

It is a further optional, non-exclusive object of the present invention to provide equipment, systems, and techniques for rotating printed materials through approximately one hundred eighty degrees.

It is also an optional, non-exclusive object of the present invention to provide equipment, systems, and techniques for rotating printed materials through approximately one hundred eighty degrees while only mechanically assisting with the initial ninety degrees of such rotation.

It is an additional optional, non-exclusive object of the present invention to provide equipment, systems, and techniques for sensing approach of materials needing to be turned and causing rotation of a shaft of the equipment.

Other objects, features, and advantages of the present invention will be apparent to those skilled in appropriate fields with reference to the remaining text and the drawings of this application.

### BRIEF DESCRIPTION OF THE DRAWINGS

FIG. 1 is a perspective view of a sample book for use with the present invention.

FIGS. 2A-D are schematicized, elevational views of equipment of the present invention.

FIG. 3 is another schematicized, elevational view of equipment including that of FIGS. 2A-D.

FIG. 4 is a schematicized, top plan view of equipment including that of FIGS. 2A-D and 3.

### DETAILED DESCRIPTION

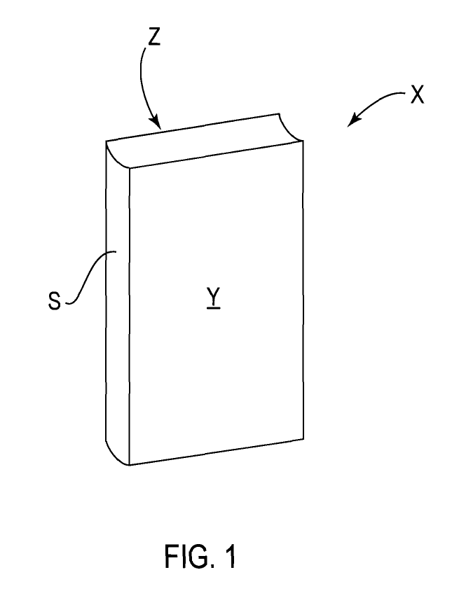

Illustrated in FIG. 1 is exemplary book X. Although identified as a “book,” book X may instead be a magazine, periodical, catalog, brochure, or other printed or unprinted document or material. As well, book X may be a signature or other portion of such a document or material. Nevertheless, book X preferably includes a first, or front, cover Y, a second, rear cover Z, and a spine or backbone S.

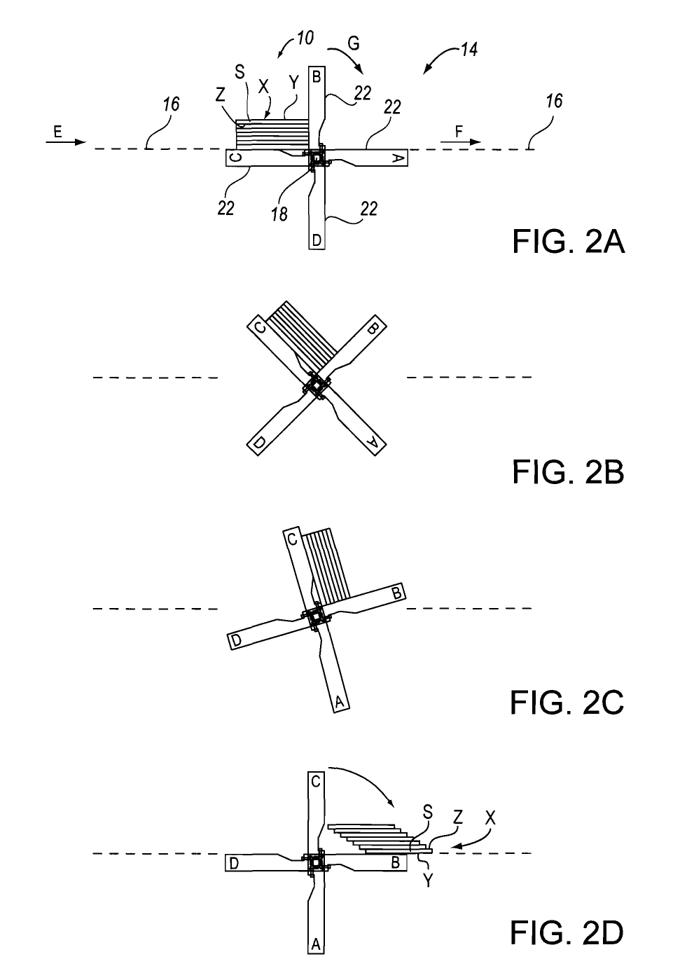

Depicted in FIGS. 2A-D and 3 is set 10 of books including book X. As shown especially in FIG. 2A, set 10 initially is oriented horizontally; book X is uppermost of the set, with front cover Y oriented upward and rear cover Z oriented downward. Backbone S of book X is oriented so as to be visible in FIG. 2A. Set 10 may approach turning equipment 14 on conveyor or belt 16 travelling in the direction identified by arrow E. Persons skilled in the art will recognize that set 10 may comprise as few as one book or as many books as feasible or desired.

Exemplary equipment 14 may comprise a rotatable shaft 18 from which arms 22 extend. In the version of equipment 14 illustrated in FIGS. 2A-D, four arms 22 (labeled “A,” “B,” “C,” and “D”) are shown. Arms 22 may be spaced approximately ninety degrees around the circumference of shaft 18 and serve as platforms for sets of books. In this embodiment of equipment 14 consistent with FIGS. 2A-D, shaft 18, and consequently arms 22, may rotate in the clockwise direction as indicated by arrow G. Of course, if the direction of linear travel of set 10 is reversed, shaft 18 may rotate counterclockwise instead.

As set 10 approaches equipment 14, arm 22B is upright (vertical), arms 22A and C are horizontal, and arm 22D extends downward (vertically). Set 10 initially may encounter and be supported by arm 22C, continuing to travel linearly until it contacts (or almost contacts) arm 22B. At approximately this time shaft 18 will rotate (see FIG. 2B), so that arm 22B begins supporting set 10. Shaft 18 continues to rotate toward ninety degrees, so that arm 22B approaches a horizontal position and arm 22C approaches a vertical one, with books of set 10 likewise approaching a vertical orientation (see FIG. 2C). Further rotation to ninety degrees causes the books of set 10 to become vertical; however, responding to centrifugal and gravitational forces, the books of set 10 continue to rotate without assistance of equipment 14, effecting “falling” onto belt 16 as illustrated in FIG. 2D.

In this rotated configuration of set 10, book X is now lowermost of the set, with front cover Y facing downward. Rear cover Z, consequently, faces upward. The “falling” action also tends to space books of set 10 horizontally, as shown in FIG. 2D, ultimately causing them to separate or “de-shingle” (i.e. no longer be stacked). As books of set 10 separate for further processing and they travel in direction F along belt 16, rear cover Z will be exposed for printing. Spine S, moreover, remains oriented so as to be visible in FIG. 2D, an advantageous result. Alternatively or additionally, other means (e.g. gates) could be used to de-shingle books of set 10 if desired. Indeed, books of some sets 10 may remain stacked even after falling onto belt 16, facilitating their being shrink-wrapped or processed in certain other ways.

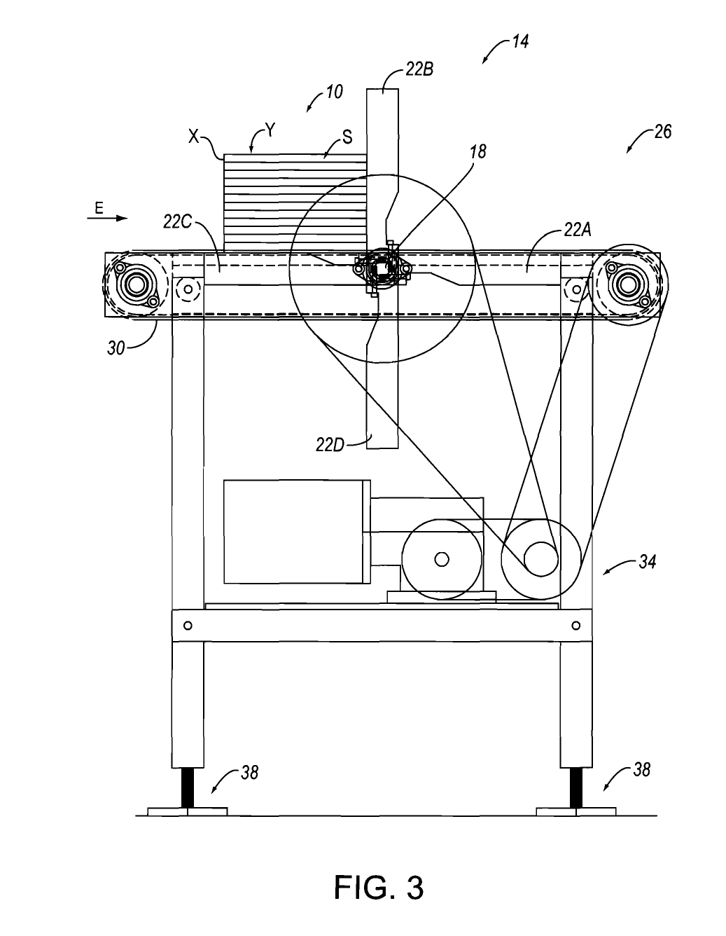

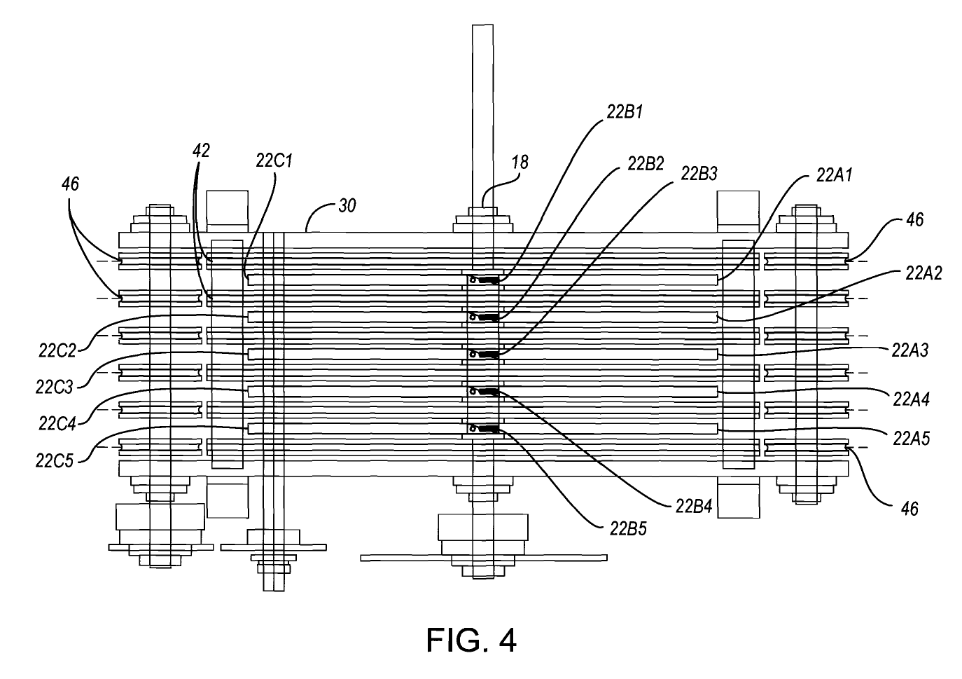

FIGS. 3-4 provide additional detail concerning exemplary equipment 14. In at least one version of the invention, equipment 14 may comprise a table-like structure 26 comprising at least platform 30, frame 34, and feet 38. Structure 26 may be placed in-line between segments of belt 16, with platform 30 being at approximately the same height as the belt 16 so as to provide a continuous horizontal path for set 10. Of course, interfacing equipment may be utilized as needed. Various motors, gears, and belts (or other means) may be employed to correlate rotation of shaft 18 with movement of set 10, preferably under control of or in response to signals directly or indirectly from a controller or sensors.

Illustrated in FIG. 4 is that each arm 22A, B, C, or D may comprise multiple segments, only one of which is depicted in the elevational views of FIGS. 2A-D and 3. Shown in FIG. 4 are segments 22A1-5, 22B1-5, and 22C1-5, which are spaced along the width of platform 30. Between segments, platform 30 may include lengthwise-extending support members 42, although such members 42 may not always be necessary. Indeed, if desired each of arms 22A-D may be widened so as to support set 10 with as few as one (or more) segments. Further, one or more of arms 22A-D may be omitted in certain configurations or redistributed angularly about the circumference of shaft 18. Platform 30 additionally may, in some cases, include either driven or freely-rotating rollers 46.

The foregoing is provided for purposes of illustrating, explaining, and describing embodiments of the present invention. Modifications and adaptations to these embodiments will be apparent to those skilled in the art and may be made without departing from the scope or spirit of the invention. Additionally, the contents of the Bellanca and Bulka patents are incorporated herein in their entireties by this reference.

What is claimed is:

1. A method of turning material comprising:
a. providing material having a first cover, a second cover, and a backbone;
b. conveying the material along a generally-horizontal conveyor with the first cover facing upward, the second cover facing downward, and the backbone facing in a first direction;
c. supporting the material on a generally-horizontal first arm; and
d. rotating the first arm in a manner causing the first cover to face downward, the second cover to face upward, and the backbone to continue to face in the first direction.

2. A method according to claim 1 in which rotating the first arm comprises rotating the first arm upward toward a generally-vertical position so that natural forces continue rotating the material to cause the first cover to face downward and the second cover to face upward.

3. A method according to claim 2 further comprising:
a. providing a second arm initially oriented generally vertically; and
b. rotating the second arm toward a generally-horizontal position when the first arm is rotated toward the generally-vertical position.

4. A method according to claim 3 in which rotating the second arm causes the second arm to support the material.

5. A method according to claim 4 further comprising sensing a position of the material on the conveyor and controlling rotation of the first and second arms based on the sensed position.

6. A method according to claim 5 further comprising, after the second arm is rotated to the generally horizontal position, conveying the material along a generally-horizontal conveyor with the first cover facing downward, the second cover facing upward, and the backbone facing in a first direction.

7. A method according to claim 6 further comprising printing mailing information on the upwardly-facing second cover.

8. A system for turning material having a first cover, a second cover, and a backbone, the system comprising:
a. a generally-horizontal conveyor for conveying the material with the first cover facing upward, the second cover facing downward, and the backbone facing in a first direction;
b. a first arm, initially generally horizontally positioned, for supporting the material; and
c. means for rotating the first arm in a mariner causing the first cover to face downward, the second cover to face upward, and the backbone to continue to face in the first direction.

9. A system according to claim 1 in which the first arm rotating means comprises means for rotating the first arm upward toward a generally-vertical position so that natural forces continue rotating the material to cause the first cover to face downward and the second cover to face upward.

10. A system according to claim 9 further comprising:
a. a second arm initially oriented generally vertically; and
b. means for rotating the second arm toward a generally-horizontal position when the first arm is rotated toward the generally-vertical position.

11. A system according to claim 10 further comprising means for sensing a position of the material on the conveyor and controlling rotation of the first and second arms based on the sensed position.

12. A system according to claim 11 further comprising means for printing mailing information on the upwardly-facing second cover.

13. A system according to claim 8 in which the material is a book.

14. A method according to claim 1 in which providing material comprises providing a book.

15. A method of turning material comprising:
a. conveying the material in a first orientation;
b. rotating the material through at least approximately ninety degrees; and
c. conveying the rotated material in a second orientation.

16. A method according to claim 15 in which the action of rotating the material through at least approximately ninety degrees causes natural forces to continue rotating the material through approximately one hundred eighty degrees.
